(19) United States
(12) Patent Application Publication
(10) Pub. No.: US 2024/0046221 A1
(43) Pub. Date: Feb. 8, 2024

(54) Electronic Meeting Suggestion Generator with Accommodations

(71) Applicant: Microsoft Technology Licensing, LLC, Redmond, WA (US)

(72) Inventors: Tariq SHARIF, Sammamish, WA (US); Chiquita Ashok KERUR, Kirkland, WA (US); Jaya MATTHEW, Redmond, WA (US); Mohit MEHTANI, Redmond, WA (US); Chanchal Ravindra KARIWALA, Redmond, WA (US); John Elliot ROBIA, Kirkland, WA (US); Charlie Ricafort CHUNG, Tacoma, WA (US); SURI RAMAN, Mercer Island, WA (US)

(21) Appl. No.: 18/268,408

(22) PCT Filed: Dec. 13, 2021
(86) PCT No.: PCT/US2021/063160

§ 371 Date: Jun. 20, 2023

(30) Foreign Application Priority Data
Jan. 29, 2021 (LU) LU102456

(51) Int. Cl. G06Q 10/1093; H04L 12/18

(52) U.S. Cl. CPC G06Q 10/1095; H04L 12/1818

(57) ABSTRACT

A computer implemented method for scheduling a meeting includes receiving a set of input parameters as meeting constraints. The meeting input parameters include a meeting organizer attendee identifier and multiple additional meeting attendee identifiers, a duration of the meeting, and a time frame within which to schedule the meeting. Calendar data is accessed from one or more servers storing calendar data corresponding to the organizer attendee and the meeting attendees based on the respective identifiers. The accessed calendar data is processed against the received set of input parameters to identify candidate meetings. In response to no candidate meeting matching all the input parameters, at least one parameter is automatically adjusted, and new candidate meetings are identified. Candidate meeting suggestions are communicated to a meeting organizer.

### CLAIM OF PRIORITY

This application claims the benefit of priority to Luxembourg Patent Application No. LU102456, filed Jan. 29, 2021, which application is incorporated herein by reference in its entirety.

### BACKGROUND

Scheduling meetings using electronic calendars can be a very rigid user experience. The user provide input with information identifying a desire to schedule a meeting, identification of attendees, room/resources that are to be included in that meeting, the duration of the meeting, and the timeframe during which the user is trying to schedule the meeting. Based on these inputs, the electronic calendar provides a response that is mostly binary, indicating where either everyone is available or not. This user experience may result in the user to iteratively adjust the input by varying attendees, duration, time windows, etc.) in an attempt to find a time slot that works best. Such iterative adjustment can be time consuming and frustrating, as well as resulting in a meeting time slot that is suboptimal.

### SUMMARY

A computer implemented method for scheduling a meeting includes receiving a set of input parameters as meeting constraints. The meeting input parameters include a meeting organizer attendee identifier and multiple additional meeting attendee identifiers, a duration of the meeting, and a time frame within which to schedule the meeting. Calendar data is accessed from one or more servers storing calendar data corresponding to the organizer attendee and the meeting attendees based on the respective identifiers. The accessed calendar data is processed against the received set of input parameters to identify candidate meetings. In response to no candidate meeting matching all the input parameters, at least one parameter is automatically adjusted, and new candidate meetings are identified. Candidate meeting suggestions are communicated to a meeting organizer.

### BRIEF DESCRIPTION OF THE DRAWINGS

FIG. 1 is a flowchart illustrating an example computer implemented method of finding meetings times while facilitating scheduling accommodations.

FIG. 2 is a block diagram of an example user interface for use by a meeting organizer in requesting a meeting by specifying parameters for the meeting.

FIG. 3 is a screen shot representation of an example user interface for communicating a new candidate meeting suggestion to the meeting organizer.

FIG. 4 is a screen shot representation of an example user interface for communicating a new candidate meeting suggestion to the meeting organizer.

FIG. 5 is a block flow diagram illustrating an example of processing requests for finding meeting times.

FIG. 6 is a block flow diagram illustrating an example parallel processing system for processing meeting requests via multiple processors.

FIG. 7 is a flow diagram illustrating an example parallel process flow utilizing multiple processors.

FIG. 8 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example implementations is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system or a container in a cloud-based system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

A scheduling system processes a meeting availability request interface to discover meeting times for a plurality of attendees. Based on an initial meeting request identifying multiple attendees, accommodations are taken into account in order to provide a meeting organizer with different options for scheduling the requested meeting. The accommodations may include variations in one or more meeting parameters specified in the meeting request, such as attendee availability, duration of the requested meeting and time frame within which to schedule the meeting.

The meeting parameters are automatically adjusted by the scheduling system to identify a new candidate meeting that does not meet all the initially specified parameters in the meeting request. In many cases, one or more attendees may not be available during the specified time frame. Candidate meeting suggestions may be provided back to the organizer based on the varying of one or more of the meeting parameters.

In various examples, attendee parameters may include the meeting organizer, various people to include in the meeting, resources, such as equipment, desired for the meeting, and even desired locations for the meetings. Each attendee is identified by an identifier, such as an email address or other identifier from which a schedule of the attendee may be accessed. The schedules of the attendees are accessed by the scheduling system to obtain availability data, such as various time slots for each attendee of a predetermined duration, such as ½ hour slots.

The time slots of each attendee are then compared to determine if all the attendees are available for the specified duration during the specified time frame. If such time slots are found to be available, one or more available meeting times are provided back to the organizer for acceptance and scheduling of the meeting.

In one example, the scheduling system analyzes alternatives by process of elimination. For example, consider a scenario of user A, the meeting organizer, trying to schedule a meeting with attendees X, Y. and Z for one hour anytime during a Tuesday and there appears to be no such time window for an hour where everyone is available. The scheduling system and user interface may provide different meeting suggestions with one or more accommodations.

If all the attendees, X, Y, and Z are available for an hour slot on Tuesday except for the organizer, user A, the scheduling system will suggest via a calendar based user interface to the user that everyone can meet except for user A and suggest to user A to resolve their scheduling conflict. In this example, the organizer, user A, sent a candidate meeting suggestion offering user A to accommodate by accepting the candidate meeting and revise their schedule to meet on Tuesday for one hour as everyone is available except user A, the organizer.

In a further example, if all of the attendees, X, Y, and Z and the organizer, A are available, however the duration they are available for is for less than the specified duration of 1 hour, the scheduling system will analyze the meeting parameters and accessed schedule data for each attendee and provide a new candidate meeting suggestion to the meeting organizer, user A. The new candidate meeting suggestion may offer to reduce the meeting duration to duration for which everyone is available. The meeting organizer is thus offered a meeting time for which the user may make an accommodation to adjust the specified duration of the meeting as all the attendees are available for only a shorter period of time than the specified duration during a specified time frame.

In yet a further example, if all the attendees, X, Y, and Z and the organizer attendee A are available, except for one attendee X, for specified duration of 1 hour on Tuesday, the scheduling system analyze the meeting parameters and accessed schedule data for each attendee and generate a new candidate meeting suggestion to the organizer, user A, that everyone is available except for X. In this example the user is being asked to accommodate by scheduling the meeting without one of the attendees as everyone is available except for X for the desired meeting on Tuesday for 1 hour.

In still a further example, if everyone is available for the desired duration for a time frame outside of the specified time frame, such as a next day or prior day the scheduling system will analyze the meeting parameters and accessed schedule data for each attendee and generate a new candidate meeting suggestion the asks user A to consider scheduling the meeting by moving the meeting to another day. In this example the user is being asked to accommodate based on the time frame parameter as there are no reasonable time slots available during the specified time frame the user intended the meeting for, however there are slots available outside the timeframe parameter, such as before or after the timeframe specified in the timeframe parameter. The slots may even be on different days in some examples.

By offering one or more of the above accommodations, meetings are more likely to be scheduled. Conflicts that resulted in the new candidate meeting suggestions may be identified in the suggestions. Providing conflict information helps the organizer select whether or not to accept the new candidate meeting suggestion and reduces email traffic involved in setting up meetings, making the scheduling system more efficient. Multiple new candidate meeting suggestions may be provided in further examples to give the organizer options, making a better human-machine interface into the scheduling system enabling a user to more efficient navigate in the scheduling system, particularly when there are a large number of attendees.

By providing a mechanism to calculate different types of accommodations in parallel, options for scheduling the meeting may be calculated in parallel to provide candidate meeting suggestions optimized on the different parameters much more quickly in real time than before, decreasing delays in scheduling meetings and increasing the chances of meeting actually being scheduled. Two or more of the accommodations identified above may be assessed in parallel, with each accommodation utilizing a copy of the same data and then a decision about the optimum accommodation being made by a decision software.

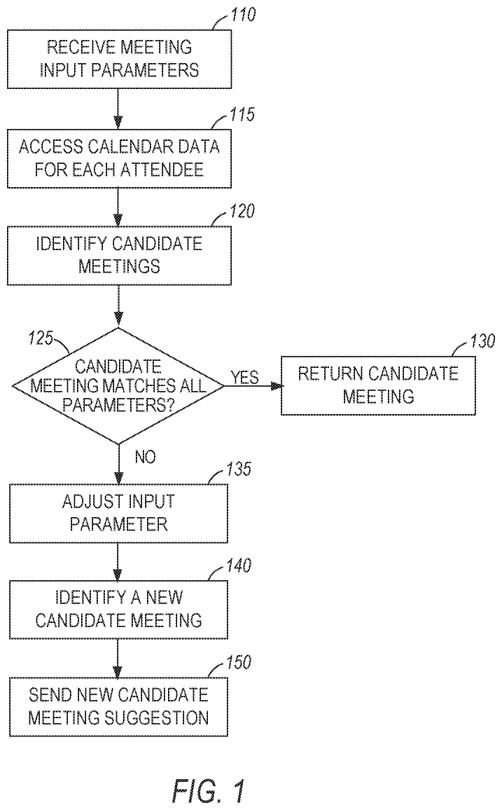

FIG. 1 is a flowchart illustrating a computer implemented method 100 of finding meetings times while facilitating scheduling accommodations. Method 100 begins at operation 110 by receiving a set of input parameters from a meeting organizer attendee. The input parameters may be specified by the organizer via a user interface that generates a request for a meeting with suggestions that may allow accommodations to be made in response to available meeting times not meeting all the input parameters. Note that the user interface may include display screens on smart phone, laptops, and touchpads as well as speech based devices or software, such as Cortana® software.

Various input parameters may include a meeting organizer attendee identifier and multiple additional meeting attendee identifiers. The identifiers may be email addresses in the case of attendees being people. The identifiers may also be some unique identifier for each attendee, such as an equipment identifier in the case of a meeting organizer desiring certain equipment to be available for the meeting, such as a whiteboard, teleconferencing equipment, projectors, etc.

Additional input parameters may include a duration of the meeting and a time frame during which the meeting is desired to be scheduled. Calendar data from one or more servers storing calendar data is accessed at operation 115. The calendar data corresponds to the organizer attendee and the meeting attendees and is based on the respective identifiers. The calendar data may include time slots available per attendee over the time frame parameters and on either side of the time frame parameter if desired.

At operation 120, the calendar data is processed against the received set of input parameters to identify candidate meetings. If at least one candidate meeting meets the input parameters as indicated at decision operation 125, meeting data for one or more candidate meetings is returned to the organizer at operation 130.

In response to no candidate meeting matching all the input parameters at decision operation 125, one or more input parameters is adjusted at operation 135 and a new candidate meeting is identified at operation 140. Note that multiple iterations of adjusting input parameters and finding new candidate meetings may be performed to identify multiple new candidate meetings. The one or more new candidate meeting suggestions is sent to the organizer at operation 150. The new candidate meeting or meeting suggestions may include indications of one or more accommodations required to be made by accepting one of the meeting suggestions.

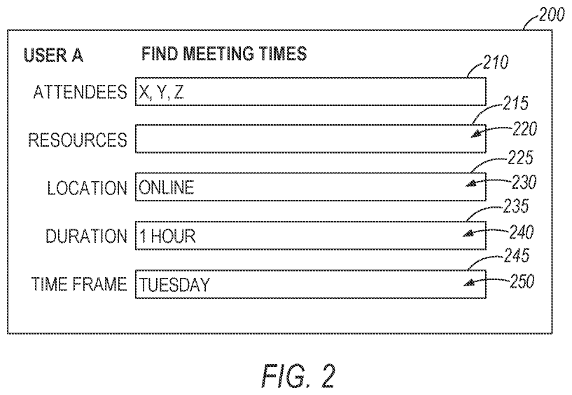

FIG. 2 is a block diagram of a user interface 200 for use by a meeting organizer in requesting a meeting by specifying parameters for the meeting. Interface 200 may be implemented as a fillable form with fields corresponding to the meeting input parameters and may be used to populate a call to a find meeting operation to be provided to an electronic calendar management system. Fields may include an attendee field 210 for specifying people desired by an organizer to attend the meeting to be scheduled. Field 210 may accept identifiers of attendees. Email addresses may be used for such identifiers and also for communication of meeting notices to such attendees. Field 215 may be included for resources needed for the meeting. A drop down menu icon 220 may be used to display a list of selectable resources, such as equipment desired for the meeting. Identifiers for resources may also be email addresses or other forms of identifying the resources such as unique ids or types of equipment, which may or may not have a unique identifier by may be part of a tracked inventory of such equipment available for meetings.

Field 225 may be used to specify a location for the meeting, such as on-line, or one or more conference rooms or types of conferences rooms. Locations may also have an identifier, which may also be an email address or other identifier such as a conference room ID that describes the location of a conference room by building, floor, and room number for example. My office may also be an identifier. Locations may also be selected via a drop down menu icon 230.

Field 235 may be used to specify a duration either by manual entry of a duration or via a drop down menu icon 240. Durations may have increments of 1 hour, ½ hour, 15 minutes or other durations.

Field 245 may be used to specify time frames during which it is desired that the meeting be scheduled. Drop down menu icon 240 may be used to specify ranges of time, such as a particular day, days, hour range within a day, or other time frames.

Example meeting input parameters for use in a call to a find meeting times operation may be defined as follows:

| Parameter | Type | Description |
|---|---|---|
| Attendees | attendeeBase collection | A collection of attendees or resources |
| | | for the meeting. An empty collection |
| | | causes the suggest meeting |
| | | times operation to look for free time |
| | | slots for only the organizer. Optional. |
| locationConstraint | locationConstraint | The organizer's requirements |
| | | about the meeting location, such |
| | | as whether a suggestion for a |
| | | meeting location is required, or |
| | | there are specific locations only |
| | | where the meeting can take place. |
| | | Optional. |
| meetingDuration | Edm.Duration | The length of the meeting, denoted |
| | | in ISO8601 format. If no meeting |
| | | duration is specified, the suggest |
| | | meeting times operation uses the |
| | | default of 30 minutes. Optional. |
| returnSuggestion | Edm.Boolean | Specify True to return a reason for |
| Reasons | | each meeting suggestion in the |
| | | suggestion reason property. The |
| | | default is false to not return that |
| | | property. Optional. |
| timeConstraint | timeConstraint | Any time restrictions for a meeting, |
| | | which can include the nature of the |
| | | meeting (activityDomain property) and |
| | | possible meeting time periods |
| | | (timeSlots property). Find meeting |
| | | times call assumes activityDomain as |
| | | work if you do not specify this |
| | | parameter. Optional. |

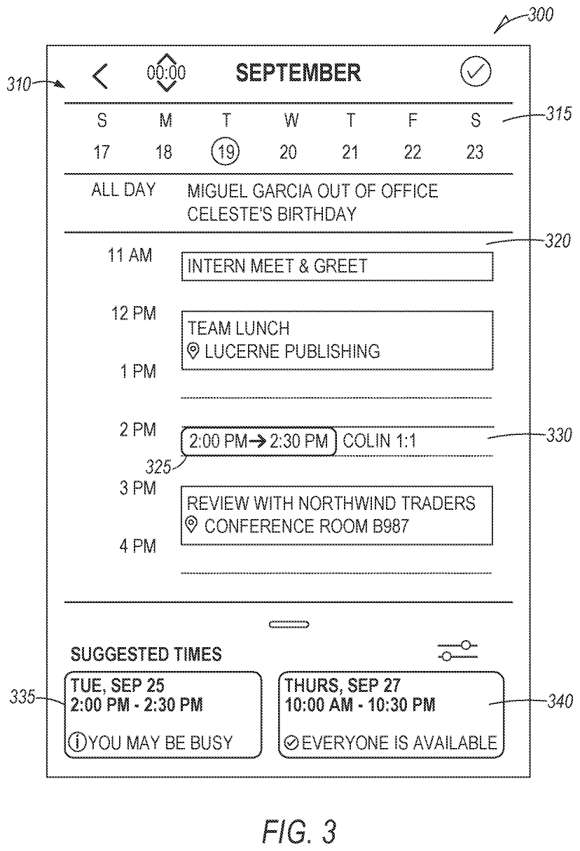

FIG. 3 is a screen shot representation of a user interface 300 for communicating a new candidate meeting suggestion to the meeting organizer. In one example, the requested meeting was for a duration of ½ hour. The new candidate meeting suggestion in interface 300 may include a calendar representation indicated generally at 310 which shows the week at 315, and a representation of the day time slots at 320 with meeting titles and times. One of the slots indicates a suggested meeting time at 325, which as can be seen conflicts with a conflicting meeting 330 at 2 PM. Detail for a first suggested time is shown at 335 with an indication of the date, time slot, and an indication that the user/organizer may be busy.

The new candidate meeting suggestion in one example includes a reason for the suggested time at 340, indicating that everyone else is available at the suggested time. If the user desires to accept that time by perhaps moving the conflicting meeting 330 to a different time, the user may simply select the suggested meeting by double clicking on or otherwise selecting the representation of the suggested meeting time 325 or optionally at 335, causing a meeting notice to be sent to all the other attendees.

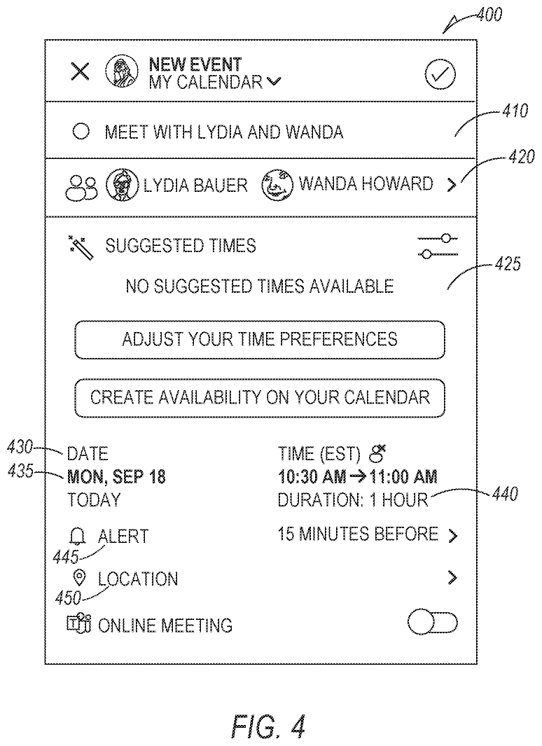

FIG. 4 is a screen shot representation of a user interface 400 for communicating a new candidate meeting suggestion to the meeting organizer. Note that user interface 400 may be in the form of a modified or revised meeting form used to select the meeting parameters. The requested meeting resulting in the user interface 400 being generated was for a duration of one hour. No one time slot was found to be available that matched all the input parameters.

Interface 400 includes a meeting subject field 410, attendee field 420, and a suggested meeting times section 425. Suggested meeting times section 425 contains a date field 430, suggested meeting time slot field 435, and a requested duration field 440 identifying the requested duration. Note that the suggested meeting time slot field 435 shows a duration of only ½ hour as opposed to the requested duration of one hour. The suggested meeting time slot field 440 information may have a text attribute such as a bolding or other attribute intended to inform the organizer that the candidate meeting suggestion does not meet all the meeting parameters. The organizer may choose to select the meeting if desired by clicking on the information at 435 or otherwise.

Interface 400 may also include fields identifying a request for an alert at 445 and a location at 450.

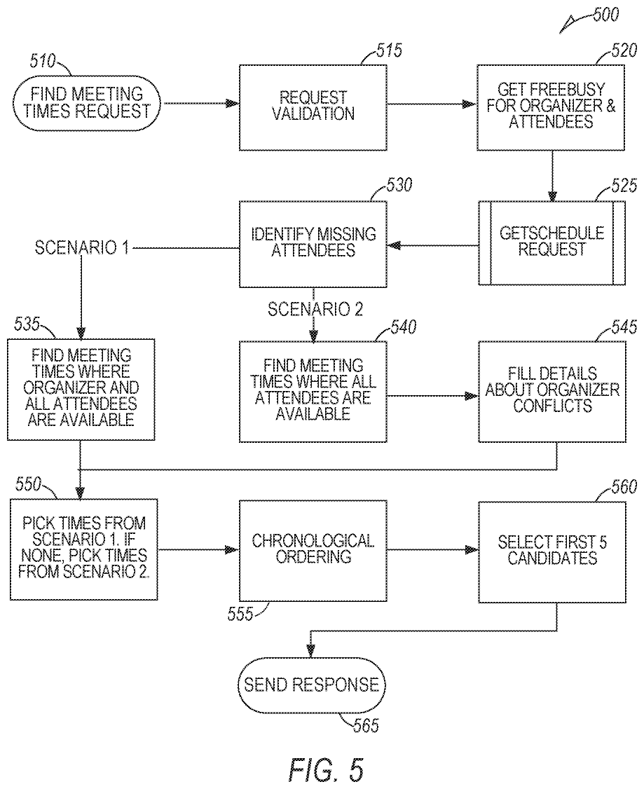

FIG. 5 is a block flow diagram illustrating an example of processing requests for finding meeting times generally at 500. Processing begins at 510 upon receipt of a find meeting times request. The request may include an indication that accommodations should be calculated in addition to prior processing that simply identifies times that satisfy all parameter values in the request. The request is validated at 515 to ensure sufficient parameters are identified and that the format of specification is correct. At 520, available time slots are found for all attendees by accessing calendar data for each attendee. Note that an existing get free busy call may be used to obtain such slots. At 525, a schedule request is processed to identify overlapping available time slots for the attendees. At 530, one or more attendees that don't have available calendar data may be identified.

In one example at 530, attendees are treated in the following manner for availability determinations. Unknown/missing attendees are considered free with a confidence of 100%. Time slots containing tentative events identified from attendee calendar data are considered as busy time slots. An attendee time slot that appears not explicitly “free” are considered as busy time slots. Treating such time slots as available can create problems whereby the attendee declines the meeting in favor of the tentative meeting. A maximum of 5 suggestions are returned in response as a default. The maximum number may be configured in a settings field. Results in chronological order. Chronological ranking sorts meeting times by their start times. Organizer accommodations will be performed by default. Organizer accommodations will have details about conflicts.

In a first scenario, meeting times where all attendees, including the organizer attendee are available are found at 535. Alternatively, in a second scenario at 540, meeting times where all attendees, except the organizer attendee are found. Note that in further examples, both the first and second scenarios may be performed at least partially in parallel. At 545, details regarding organizer conflicts with the found meeting times are identified and filled in to populate a candidate meeting suggestion communication.

At 550, candidate meeting suggestions are selected from scenario 1. If there are no times available in scenario 1, candidate meeting suggestions from scenario 2 are selected and placed in chronological order at 555. At 560, a selected number of candidate meeting suggestions, such as up to five, are used to populate a response identifying candidate meeting suggestions. The response is sent to the organizer at 565.

Further detail regarding the processing of a find meeting times request is now provided for each scenario. Note that scenario 1 is consistent with the current operation of Microsoft Outlook calendar scheduling functions. In scenario 1, no accommodations are needed, as there is at least one meeting time available that complies with all specified meeting parameters. If the organizer does not have any free slots, an empty suggestions list is returned with an empty suggestions reason of ‘Organizer Unavailable’.

Scenario 1 is implemented in one example with an organizer availability operation performed as follows:
1. For each organizer free slot, fill the attendee availability. [Attendee availability operation]
   a. Tentative, OOF (out of office). Busy are considered as Busy.
   b. If an attendee's availability is unknown, they will be considered as free for all the timeslots.
2. Return the slots where everybody is available.
3. If slots are not found where everyone is available, return an empty suggestions list with an empty suggestions reason of ‘Attendees unavailable’.

Scenario 2 results in the finding of timeslots where all attendees excluding the organizer are available. In one implementation, the finding of such timeslots is a parallel operation set and may be added to a pipeline builder class for an API for a meeting times pipeline builder. After processing for both the scenarios (1 and 2) in parallel, time slots are identified where everyone is available and returned. If there are insufficient results where everyone is available, time slots padded with organizer accommodations, if any, are returned. Otherwise an empty result with a hint message may be returned using a post-processing operation referred to as choose scenario results operation.

Organizer accommodations may be calculated by the following method.

Capture additional details for the Organizer's existing events including availability status, subject, and ID from their calendar. If there are multiple conflicting meetings, then return all the conflicts for that time slot suggestion. Update the results to have the status, subject and ID details. An interface/type such as, event details, may be used to hold the additional details as a new property of a time slot interface. This may be populated in an availability reader class during an attendee free busy operation at the start of the pipeline by using the existing data from a get schedule response which already contains the status and subject properties, and the event ID can be retrieved using a private header referred to as calendar internal.

Next, find time slots where all the other attendees are available. An existing attendees availability operation may be used to identify such other attendees. Each of the free time slot found are compared with the Organizer's unavailable slots, optionally including Busy, OOF and Tentative (if considered) times. Any events where the organizer is free will be discarded by looking at all types of the conflicts including the ones where the organizer is an attendee to let the organizer decide the importance of that event.

Once the final slots are returned to the client with the organizer details updated in the results, this along with an accommodation type property will be added to a meeting time suggestion response object data contract class. The data may be carried in a new data model class such as accommodation data model.

Finally, a build response method is updated to add these new properties to generate suggestions based on accommodations.

In both the above scenarios, if no free timeslots are found for all candidates, then an empty response is returned with a hint/message detailing the same. The meeting suggestions may be sorted in chronological order with up to the first 5 candidates included in the response.

Ordering may be performed by returning suggestions may be returned in chronological order by start time. An empty suggestion reason may include an indication that attendees are unavailable or unknown.

For implementing scenario 1, preferences are first be applied, such as time zone and defining parameters for suggestion reason, and meeting time suggestions. Parameters for organizer availability and other attendee availability are also defined. Values for such fields are “free” for scenario 1 corresponding to meeting times defined as time slots with a staring time, time zone, and data and an ending time and time zone, when all attendees including the organizer are available. The suggestion returned in one example is “Suggested because it is one of the nearest times when all attendees are available.” The same suggestion is provided if some of the attendees have an availability of “unknown” in one example. Note that if there are no times when all are available in scenario 1, a reason suggestion field indicating ‘Attendees unavailable’ is generated and communicated to the user.

Scenario 2 may be implemented in a manner similar to scenario 1 in defining parameters, except that a meeting organizer may have an availability of “busy.” This results in an accommodation detail having a type of “organizer conflict” being identified. The returned suggestion may indicate that the organizer is busy, but all other attendees are available. Details regarding the conflicting meeting scheduled for the organizer may also be provided.

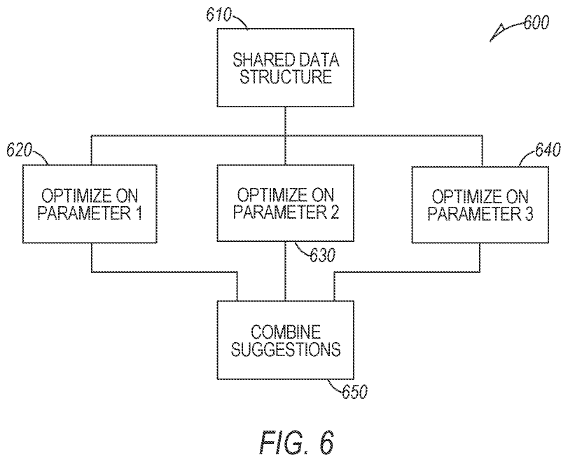

FIG. 6 is a block flow diagram illustrating a parallel system 600 for processing meeting requests via multiple processors. A shared data structure 610 contains the meeting input parameters and the stored calendar data for use in finding meeting suggestions. The data structure 610 is accessed by multiple processors indicated at 620, 630, and 640. Each of the multiple processors is configured to optimize the finding of meeting suggestions based on a different meeting parameter. Threaded tasks may be used for each different type of optimization. For example, processor 520 optimizes based on a first parameter, such as finding times where all meeting attendees, including the organizer are available. Processor 530 optimizes based on a second parameter, such as finding times where all meeting attendees are available, but the organizer is not available. Processor 540 optimizes based on all attendees being available except for one attendee other than the meeting organizer.

Each of the processor or sub-processor generates a list of candidate meetings which is combined at processor 650, which may in fact may any one of processors 620, 630, 640 or yet a different processor. The lists of candidate meetings may be pruned or otherwise limited to a specified number, such as five each to limit the processing time required. The combined list may be sorted to provide the top candidate, or up to five or so candidate meetings as the new candidate meeting suggestion or suggestions. In one example, the new candidate meeting suggestions may be sorted with suggestions corresponding to all attendees being available appearing first followed by the organizer making an accommodation appearing next, and suggestions involving one other attendee not being available listed last. Each type of suggestion may also be chronologically ordered within the type.

There is a very large amount of data required to be processed in order to generate candidate meetings based on different optimizations of the data. In addition, it is desired that the data be processed quickly in order to provide candidate meetings to the organizer in real time as the organizer is attempting to schedule the meeting. Dividing up the work between processors based on different optimizations using a shared data structure versus simply having processors work in parallel on different data sets doing similar processing, enables faster processing of the data and hence a way to allow meeting organizers to not waste time waiting for candidate meeting choices.

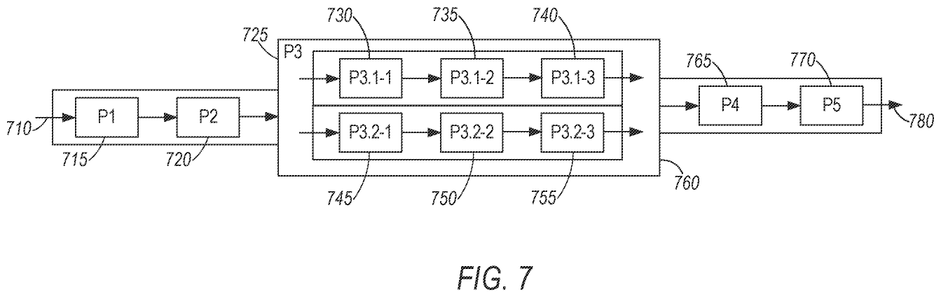

FIG. 7 is a flow diagram illustrating an example parallel pipeline system level process flow 700 utilizing multiple processors. In one example, the process flow is implemented as a microservice. Multiple such microservices may be instantiated to handle meeting requests from many users.

Operations are used to perform functions corresponding to a meeting request received at 710, initiating a meeting request process implemented by process flow 700. Operations are individual units of work performed on data flowing through the pipeline process flow 700. The meeting request process in one example is implemented utilizing separate containers, referred to as processors for ease of reference. Flow 700 is a simplified example, as there may be many more operations and processors depending on the granularity of programming desired.

The meeting request process begins with two processors 715 P1 and 720 P2 that serially perform respective operations of fetching of calendar data and preparation of the calendar data for consumption by further processors in the flow 700. At processor 725 P3, the process is split into two or more parallel streams of operations performed at further processors, which are sets of processors under processor 725 P3. In addition, a copy of the data is made available to each processor. The data is thus cloned to make multiple copies or is otherwise made accessible to processors used to perform further operations.

In a first parallel stream, sub-processors 730 P3.1-1, 735 P3.1-2, and 740 P3.1-3 for instance, operate to optimize based on finding times where all meeting attendees are available, but the organizer is not available. Sub-processors 745 P3.2-1, 750 P3.2-2, and 755 P3.2-3 are configured to optimize based on all attendees being available except for one attendee other than the meeting organizer in a second parallel stream. Further parallel streams of operations are optionally performed on further parallel processors to optimize on further meeting parameters. Each of the processors has access to the shared data structure and generates a separate list of candidate meetings.

At 760, the separate lists of candidates are provided to processor 765 for combining the separate or respective lists of candidate meetings. The heuristics prioritize in one example based on candidate meetings including an organizer accommodating their schedule having a highest priority and candidate meetings where one attendee can't make it, and then optionally ordered by meeting candidates having a meeting time closest in time to the beginning of and within the requested time period. Other heuristics are used in further examples, and optionally result in a limited number, such as five, meeting candidates being provided to processor 770 P5 to provide a final list of prioritized candidate meetings at 780 that includes one or more candidate meeting suggestions.

Changes to an existing Office 365 serial pipeline of processors have been made to support multi-level parallelization to optimize the performance of processing the meeting request while providing meaningful results. Serial operations within parallel operations are now supported as shown in processor 725 P3, each to enable optimizing based on different parameters in each operation stream to provide different lists of candidate meetings.

Utilizing the flow of FIG. 7, the processing of the calendar data includes creating a process flow having multiple operations. Identification of new candidate meetings is performed using multi-level parallelization by dividing the process into separate operation streams to execute in parallel and adjusting a different parameter in each separate operation stream to provide respective candidate meeting lists for each different parameter. The respective candidate meeting lists are combined to identify the new candidate meeting suggestion or suggestions.

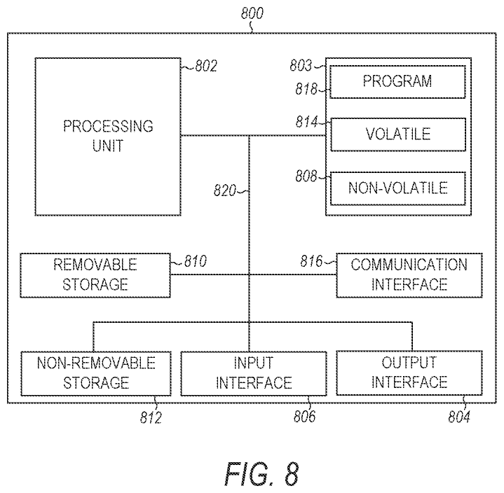

FIG. 8 is a block schematic diagram of a computer system 800 to generate meeting suggestions with accommodations, provide user interfaces and for performing other methods and algorithms according to example embodiments. All components need not be used in various embodiments.

One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, smart storage device (SSD), or other computing device including the same or similar elements as illustrated and described with regard to FIG. 8. Devices, such as smartphones, tablets, and smartwatches, are generally collectively referred to as mobile devices or user equipment.

Although the various data storage elements are illustrated as part of the computer 800, the storage may also or alternatively include cloud-based storage accessible via a network, such as the Internet or server-based storage. Note also that an SSD may include a processor on which the parser may be run, allowing transfer of parsed, filtered data through V/O channels between the SSD and main memory.

Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input interface 806, output interface 804, and a communication interface 816. Output interface 804 may include a display device, such as a touchscreen, that also may serve as an input device. The input interface 806 may include one or more of a touchscreen, touchpad, mouse, key board, camera, one or more device-specific buttons, one or more sensors integrated within or coupled via wired or wireless data connections to the computer 800, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular. Wi-Fi. Bluetooth, or other networks. According to one embodiment, the various components of computer 800 are connected with a system bus 820.

Computer-readable instructions stored on a computer-readable medium are executable by the processing unit 802 of the computer 800, such as a program 818. The program 818 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves to the extent carrier waves are deemed too transitory. Storage can also include networked storage, such as a storage area network (SAN). Computer program 818 along with the workspace manager 822 may be used to cause processing unit 802 to perform one or more methods or algorithms described herein.

### EXAMPLES

A computer implemented method for scheduling a meeting, the method including receiving a set of input parameters as meeting constraints. The input parameters include a meeting organizer attendee identifier and multiple additional meeting attendee identifiers, a duration of the meeting, and a time frame within which to schedule the meeting. The calendar data is accessed from one or more servers storing calendar data corresponding to the organizer attendee and the meeting attendees based on the respective identifiers. The calendar data is processed against the received set of input parameters to identify candidate meetings. In response to no candidate meeting matching all the input parameters, the method includes automatically adjusting at least one parameter, identifying a new candidate meeting, and communicating a new candidate meeting suggestion to the meeting organizer.

The method of the previous example wherein processing the calendar data includes dividing processing of the calendar data between multiple processors and performing identification of new candidate meetings at each of the multiple processors by optimizing based on a different input parameter in each of the multiple processors. Identifying a new candidate meeting includes identifying multiple candidate meetings at each processor, pruning the multiple candidate meetings as a function of the different input parameter to generate a sorted list of candidate meetings, combining the sorted list of candidate meetings from each processor into a final list of candidate meetings, and wherein identifying a new candidate meeting suggestion comprises selecting the new candidate meeting from the final list of candidate meetings.

The method of the previous example wherein dividing processing of the calendar data between multiple processors includes creating a shared data structure for the set of input parameters and calendar data and providing the shared data structure to each of the parallel processors.

The method of any of the previous examples wherein processing the calendar data includes creating a process flow comprising multiple operations performing identification of new candidate meetings by dividing the process into separate operation streams to execute in parallel and adjusting a different parameter in each separate operation stream to provide respective candidate meeting lists for each different parameter. The respective candidate meeting lists are combined to identify the new candidate meeting suggestion.

The method of any of the previous examples wherein the set of input parameters are received via a meeting form and wherein the new candidate meeting suggestion comprises a revised meeting form.

The method of any of the previous examples wherein the additional meeting attendee identifiers comprise at least one of a person identifier, a resource identifier, or a meeting room identifier.

The method of any of the previous examples wherein the new candidate meeting is identified based on the meeting organizer attendee having a timeframe conflict wherein all the additional meeting attendees are available during the timeframe, the method further including, receiving an indication that the meeting organizer will clear the conflict, and scheduling the meeting using the first candidate timeframe.

The method of any of the previous examples wherein the new candidate meeting is identified based on all attendees being available during a second time frame having a duration less than the duration parameter, the method further including generating a second request to schedule the meeting using the second candidate timeframe, sending the second request to the organizer attendee, receiving an acceptance in response to the sending of the second request, and scheduling the meeting using the second candidate timeframe.

The method of any of the previous examples wherein the new candidate meeting is identified based on one of the additional meeting attendees having a timeframe conflict. The method further includes sending a first request to the one attendee to clear the timeframe conflict, receiving an indication that the one attendee will clear the conflict, and scheduling the meeting using the first candidate timeframe.

The method of any of the previous examples wherein adjusting at least one parameter includes at least one of excluding on additional meeting attendee and adjusting the time frame to occur outside the input time frame parameter.

The method of any of the previous examples and further comprising identifying multiple additional new candidate meeting suggestions by adjusting one or more of the input parameters and sending the multiple additional new candidate meeting suggestions to the meeting organizer.

The method of any of the previous examples wherein processing the calendar data includes creating a process flow comprising multiple operations, performing identification of new candidate meetings by dividing the process into separate operation streams to execute in parallel to provide respective candidate meeting lists for each different parameter wherein the separate operation streams optimize based on one each of all meeting attendees being available during the timeframe, all the additional meeting attendees and not the organizer attendee being available during the timeframe, and only one of the additional meeting attendees being available during the timeframe, and combining the respective candidate meeting lists to identify the new candidate meeting suggestion.

The method of the previous example wherein combining the respective candidate meeting lists includes pruning the respective candidate meeting list, combining the respective candidate meeting lists into a combined list, and prioritizing the combined list with highest priority given to candidate meetings with all meeting attendees being available during the timeframe, next highest priority given to all the additional meeting attendees and not the organizer attendee being available during the timeframe, and lowest priority to only one of the additional meeting attendees being available during the timeframe.

A machine-readable storage device has instructions for execution by a processor of a machine to cause the processor to perform operations to perform any of the previous method examples

A device includes a processor and a memory device coupled to the processor and having a program stored thereon for execution by the processor to perform any of the previous method examples.

Although a few examples have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other example implementations may be within the scope of the following claims.

1. A computer implemented method for scheduling a meeting, the method comprising:
receiving a set of input parameters as meeting constraints, the input parameters including:
a meeting organizer attendee identifier and multiple additional meeting attendee identifiers;
a duration of the meeting; and
a time frame within which to schedule the meeting;
accessing calendar data from one or more servers storing calendar data corresponding to the organizer attendee and the meeting attendees based on the respective identifiers;
processing the calendar data against the received set of input parameters to identify candidate meetings;
in response to no candidate meeting matching all the input parameters:
automatically adjusting at least one parameter;
identifying a new candidate meeting; and
communicating a new candidate meeting suggestion to the meeting organizer.

2. The method of claim 1 wherein processing the calendar data comprises:
dividing processing of the calendar data between multiple processors; and
performing identification of new candidate meetings at each of the multiple processors by optimizing based on a different input parameter in each of the multiple processors, and wherein identifying a new candidate meeting comprises:
identifying multiple candidate meetings at each processor;
pruning the multiple candidate meetings as a function of the different input parameter to generate a sorted list of candidate meetings;
combining the sorted list of candidate meetings from each processor into a final list of candidate meetings; and
wherein identifying a new candidate meeting suggestion comprises selecting the new candidate meeting from the final list of candidate meetings.

3. The method of claim 2 wherein dividing processing of the calendar data between multiple processors comprises:
creating a shared data structure for the set of input parameters and calendar data; and
providing the shared data structure to each of the parallel processors.

4. The method of claim 1 wherein processing the calendar data comprises:
creating a process flow comprising multiple operations;
performing identification of new candidate meetings by dividing the process into separate operation streams to execute in parallel and adjusting a different parameter in each separate operation stream to provide respective candidate meeting lists for each different parameter; and
combining the respective candidate meeting lists to identify the new candidate meeting suggestion.

5. The method of claim 1 wherein the set of input parameters are received via a meeting form and wherein the new candidate meeting suggestion comprises a revised meeting form.

6. The method of claim 1 wherein the additional meeting attendee identifiers comprise at least one of a person identifier, a resource identifier, or a meeting room identifier.

7. The method of claim 1 wherein the new candidate meeting is identified based on the meeting organizer attendee having a timeframe conflict wherein all the additional meeting attendees are available during the timeframe, the method further comprising:
receiving an indication that the meeting organizer will clear the conflict; and
scheduling the meeting using the first candidate timeframe.

8. The method of claim 1 wherein the new candidate meeting is identified based on all attendees being available during a second time frame having a duration less than the duration parameter, the method further comprising:
generating a second request to schedule the meeting using the second candidate timeframe;
sending the second request to the organizer attendee;
receiving an acceptance in response to the sending of the second request; and
scheduling the meeting using the second candidate timeframe.

9. The method of claim 1 wherein the new candidate meeting is identified based on one of the additional meeting attendees having a timeframe conflict, the method further comprising:
sending a first request to the one attendee to clear the timeframe conflict;
receiving an indication that the one attendee will clear the conflict; and
scheduling the meeting using the first candidate timeframe.

10. The method of claim 1 wherein adjusting at least one parameter comprises at least one of excluding an additional meeting attendee and adjusting the time frame to occur outside the input time frame parameter.

11. The method of claim 1 and further comprising identifying multiple additional new candidate meeting suggestions by adjusting one or more of the input parameters and sending at least one of the multiple additional new candidate meeting suggestions to the meeting organizer.

12. The method of claim 1 wherein processing the calendar data comprises:
creating a process flow comprising multiple operations;
performing identification of new candidate meetings by dividing the process into separate operation streams to execute in parallel to provide respective candidate meeting lists for each different parameter wherein the separate operation streams optimize based on one each of all meeting attendees being available during the timeframe, all the additional meeting attendees and not the organizer attendee being available during the timeframe, and only one of the additional meeting attendees being available during the timeframe; and
combining the respective candidate meeting lists to identify the new candidate meeting suggestion.

13. The method of claim 12 wherein combining the respective candidate meeting lists comprises:
pruning the respective candidate meeting list;
combining the respective candidate meeting lists into a combined list; and
prioritizing the combined list with highest priority given to candidate meetings with all meeting attendees being available during the timeframe, next highest priority given to all the additional meeting attendees and not the organizer attendee being available during the timeframe, and lowest priority to only one of the additional meeting attendees being available during the timeframe.

14. A machine-readable storage device having instructions for execution by a processor of a machine to cause the processor to perform operations to perform the method of claim 1.

15. A device comprising:
a processor; and
a memory device coupled to the processor and having a program stored thereon for execution by the processor to perform the method of claim 1.
